(19) United States
(12) Patent Application Publication
(10) Pub. No.: US 2023/0280531 A1
(43) Pub. Date: Sep. 7, 2023

(54) INTEGRATED POLARIZATION CONTROLLER SYSTEMS

(71) Applicant: Voyant Photonics, Inc., New York, NY (US)

(72) Inventor: Christopher T. PHARE, New York, NY (US)

(21) Appl. No.: 18/177,246

(22) Filed: Mar. 2, 2023

Related U.S. Application Data
(60) Provisional application No. 63/315,746, filed on Mar. 2, 2022.
(60) Provisional application No. 63/316,633, filed on Mar. 4, 2022.
(60) Provisional application No. 63/346,344, filed on May 27, 2022.

(51) Int. Cl. G02B 6/126

(52) U.S. Cl. CPC G02B 6/126; G02B 2006/1215

(57) ABSTRACT

Disclosed are integrated photonics systems including polarization controllers for photonics systems which incorporate integrated photonics for implementing polarization effects in optical signals. Integrated photonic components separate, control, and combine the polarization components of optical signals, using a polarization splitter combiner, at least one phase shifter and a least one splitter.

### CROSS-REFERENCE TO RELATED APPLICATIONS

This application claims the benefit of U.S. Provisional Patent Application No. 63/315,746, filed Mar. 2, 2022, U.S. Provisional Patent Application No. 63/316,633, filed Mar. 4, 2022 and U.S. Provisional Patent Application No. 63/346,344, filed May 27, 2022, all of which are incorporated herein by reference in their entireties.

### FIELD OF THE INVENTION

The present disclosure relates to photonics systems and particularly to polarization controllers for photonics systems which incorporate integrated photonics for implementing polarization effects in optical signals.

### BRIEF SUMMARY

According to a first aspect, there is provided an integrated photonics system including: a photonics chip including a polarization controller having a polarization-side port and at least one component-side port, the polarization controller including: a polarization splitter rotator (PSR) including a first, a second, and a third port, the PSR coupled via its first port, over the polarization-side port; a first set of waveguides coupled to the second and third ports of the PSR; a first phase shifter coupled along a first waveguide of the first set of waveguides; and a first splitter including a first set of ports and a second set of ports, the first splitter coupled to the PSR via its first set of ports and over the first set of waveguides, and coupled over at least one port of its second set of ports, via the at least one component-side port of the polarization controller.

In some embodiments, the first splitter comprises a 2:1 splitter. In some embodiments, the first splitter comprises a 2:2 splitter.

In some embodiments, the first phase shifter is configured for imparting a phase shift which optimizes optical signals emerging from at least one port of the at least one component-side port of the polarization controller.

In some embodiments, the first phase shifter is configured for imparting a phase shift which generates an optical signal having a selected polarization state emerging from the polarization-side port of the polarization controller.

In some embodiments, the first phase shifter is tunable.

Some embodiments further provide for at least one power detection element coupled along the at least one component-side port of the polarization controller, and wherein the controller, the at least one power detection element, and the tunable first phase shifter are comprised in a feedback loop for tuning a first phase shift of the first phase shifter.

Some embodiments further provide for a second set of waveguides coupled to the first set of ports of the first splitter; a second phase shifter coupled along a first waveguide of the second set of waveguides; a second splitter including a first set of ports and a second set of ports, the second splitter coupled via its first set of ports to the first set of waveguides and coupled via its second set of ports to the second set of waveguides, the second splitter coupled over the first set of waveguides to the PSR and coupled over the second set of waveguides to the first splitter.

In some embodiments, the first splitter comprises a 2:1 splitter and the second splitter comprises a 2:2 splitter. In some embodiments, the first splitter comprises a 2:2 splitter and the second splitter comprises a 2:2 splitter.

In some embodiments, the first and second phase shifters are configured for imparting phase shifts which optimize optical signals emerging from at least one port of the at least one component-side port of the polarization controller.

In some embodiments, the first and second phase shifters are configured for imparting phase shifts which generate an optical signal having a selected polarization state emerging from the polarization-side port of the polarization controller.

In some embodiments, the first and second phase shifters are tunable.

Some embodiments further provide for at least one power detection element coupled along the at least one component-side port of the polarization controller and a controller, and wherein the controller, the at least one power detection element, and the tunable first and second phase shifters are comprised in a feedback loop for tuning the phase shifts of the tunable first and second phase shifters.

In some embodiments, the at least one power detection element comprises at least one photodetector coupled via a tap to at least one port of the at least one component-side ports of the polarization controller, and wherein the controller in response to signals from the at least one photodetector controls at least one electrical control signal sent to the tunable first and second phase shifters.

In some embodiments, the at least one power detection element comprises a photodetector coupled to a port of the at least one component-side ports of the polarization controller, and wherein the controller in response to signals from the photodetector controls at least one electrical control signal sent to the tunable first and second phase shifters.

In some embodiments, the first phase shifter is configured to impart a phase shift for generating a circularly polarized sensing optical signal transmitted from the polarization-side port of the polarization controller, and for outputting over one of the at least one component-side ports of the polarization controller a linearly polarized optical signal having an optical power proportional to a circularly polarized measurement optical signal received over the polarization-side port of the polarization controller, the circularly polarized sensing optical signal transmitted being of the opposite handedness to the circularly polarized measurement optical signal received.

In some embodiments, the first and second phase shifters are configured to impart phase shifts for generating a circularly polarized sensing optical signal transmitted from the polarization-side port of the polarization controller, and for outputting over one of the at least one component-side ports of the polarization controller a linearly polarized optical signal having an optical power proportional to a circularly polarized measurement optical signal received over the polarization-side port of the polarization controller, the circularly polarized sensing optical signal transmitted being of the opposite handedness to the circularly polarized measurement optical signal received.

Some embodiments further provide for a driver for driving the phase shifts of the tunable first and second phase shifters in at least one of a rapid and random fashion so as to produce an optical signal which effectively has a scrambled polarization state.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a schematic block diagram of an integrated photonics system including a type I integrated polarization controller with a single component-side port according to an embodiment.

FIG. 2 is a schematic block diagram of an integrated photonics system including a type I integrated polarization controller with two component-side ports according to an embodiment.

FIG. 3 is a schematic block diagram of an integrated photonics system including a type II integrated polarization controller with a single component-side port according to an embodiment.

FIG. 4 is a schematic block diagram of an integrated photonics system including a type II integrated polarization controller with two component-side ports according to an embodiment.

FIG. 5 is a schematic block diagram of an integrated photonics system including a controllable type II integrated polarization controller with a single component-side port and feedback according to an embodiment.

FIG. 6 is a schematic block diagram of an integrated photonics system including a controllable type II integrated polarization controller with one component-side port used for feedback according to an embodiment.

FIG. 7 is a schematic block diagram of an integrated photonics system including a type I or type II integrated polarization controller implemented in a circular polarization reflectance sensor according to an embodiment.

FIG. 8. is a schematic block diagram of an integrated photonics system including a type II integrated polarization controller implemented as a polarization scrambler according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope of an invention as defined by the appended claims.

### DETAILED DESCRIPTION

Photonics systems utilize a host of structural and functional elements to guide, launch, manipulate, or otherwise utilize photonic signals to their desired application. In many such systems the polarization states of light are exploited or otherwise put to useful application in whatever manner depending upon the context. In modern silicon photonics, integration of as much structure and function into on-chip devices has advantages over free-space elements, including optimization of size, cost, optical performance, to name but a few. Whether in light detection and ranging (LIDAR) or any other photonics application, use and control of the polarization states of light can be complex and/or bulky, sometimes involving large birefringent blocks or waveplates, etc. and conversion from on-chip to free-space polarization optics and back can introduce unwanted insertion loss.

The present disclosure describes on-chip solutions for converting, controlling, and utilizing polarization states of light avoiding or mitigating problems associated with polarization controllers consisting only of free-space optics.

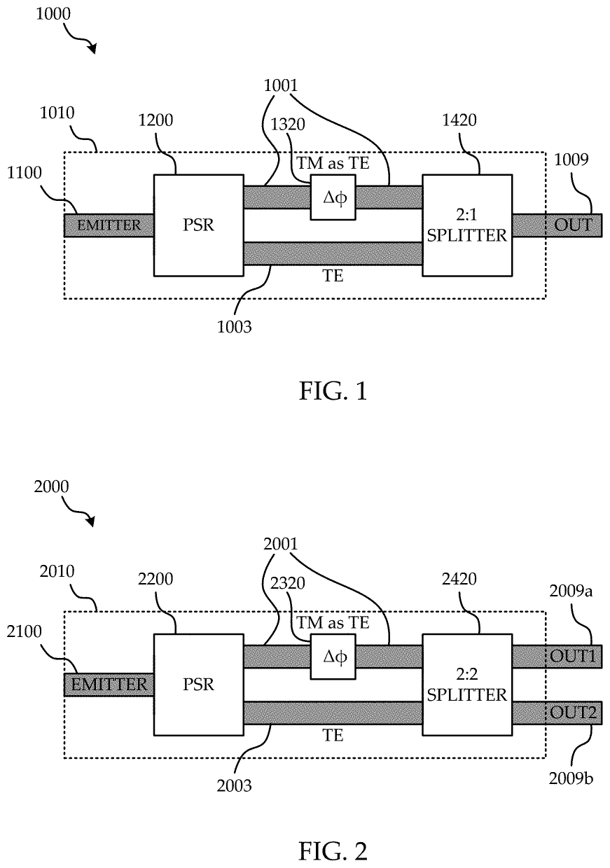

With reference to FIG. 1 an integrated photonics system 1000 including a type I integrated polarization controller according to an embodiment will now be discussed.

Many of the variations of the on-chip solution described below can be utilized with optical signals traversing in either direction or both directions simultaneously. Consequently, rather than characterizing any of the various device ports structurally as inputs or outputs, aspects of the devices and structure may be described as “polarization-side” or “component-side”. As will become clear in the following, “polarization-side” will refer to a side or direction of the devices from which or to which polarized optical signals are received or transmitted and “component-side” will refer to a side or direction of the devices from or to which the components of the polarized optical signals (in the form of linearly polarized signals) are received or transmitted.

The integrated photonics system 1000 includes an integrated polarization controller 1010 including an arrangement of on-chip photonics devices for converting any polarization state with orthogonal components e.g. Eₓ and E_{y} (TE and TM) having equal amplitudes, into a polarization state having substantially all of the incident power in a single component direction, e.g. Eₓ or TE. For example, an optical signal which is 45° linearly polarized (e.g. from the x-axis), either of a “diagonal” or “anti-diagonal” polarization state, right-hand circular polarized (RHCP), left-hand circular polarized (LHCP), or in any elliptical polarization state which is formed by a combination of TE and TM of equal amplitudes and out-of-phase by amounts other than ±π/2, 0, or π, may be converted into a linear polarization state e.g. TE of substantially the same power as the original optical signal.

With respect to structure, starting from a polarization-side of the system 1000, a first port of an emitter 1100 serves as the polarization-side port of the integrated polarization controller 1010. The emitter 1100 may be any free-space to chip converter that supports both polarization components (TE and TM), such as a grating or inverse taper, etc. A second port of the emitter 1100 is coupled to a single polarization-side port of a polarization splitter rotator (PSR) 1200 which is coupled via its component-side ports over a first set of waveguides 1001 1003 to a first set of ports on a polarization-side of a 2:1 splitter 1420. A first component-side port of the PSR is coupled to a first waveguide 1001 and a second component-side port of the PSR is coupled to a second waveguide 1003. A phase shifter 1320 is coupled along the first waveguide 1001. The first waveguide 1001 is coupled to a first port of the 2:1 splitter 1420, and the second waveguide 1003 is coupled to a second port of the 2:1 splitter 1420. A component-side of the 2:1 splitter 1420 is coupled via a second set of ports, consisting of a single third port, to a component-side port 1009 of the integrated polarization controller 1010, represented here as a waveguide coupled to further optical components which utilize the polarization converted optical signal.

With respect to function, an original optical signal of the original polarization state is input to the integrated polarization controller 1010 at the emitter 1100. After traversing the emitter 1100, the optical signal enters the polarization splitter rotator (PSR) 1200 which splits the orthogonal polarization components of the optical signal, rotates one of them, and outputs them on separate component-side ports. The E_{y} component (TM) of the incoming optical signal is rotated 90° into a TE polarization, and output as a first component optical signal from a first component-side port of the PSR 1200 along the first waveguide 1001 “TM as TE”. The Eₓ component (TE) of the incoming optical signal is output as a second component optical signal from a second component-side port of the PSR 1200 along the second waveguide 1003 “TE”. The TE and TM polarization components of the optical signal see different phase shifts traversing both the emitter 1100 and the PSR 1200, since generally the effective indices affecting the TM and TE components are not equal. This will be reflected in the phases of the first and second component optical signals emerging from the PSR 1200. For the purposes of the operation of the polarization controller 1010, the absolute phases of the optical signals traversing the first set of waveguides 1001 1003 do not matter, only the relative phase difference Δθ between the optical signal traversing the first waveguide 1001 and the optical signal traversing the second waveguide 1003 matters. This relative phase difference Δθ depends not only on the phase shifts caused by the emitter 1100 and PSR 1200, but also on the original phase difference between the orthogonal polarization components of the original optical signal. The first component optical signal “TM as TE” passes through the phase shifter 1320 coupled along the first waveguide 1001 which imparts a phase shift of Δϕ in the first component optical signal. A phase shifted first component optical signal emerges from the phase shifter 1320, traverses the remainder of the first waveguide 1001 and enters the 2:1 splitter 1420 via its first port. The second component optical signal traverses the second waveguide 1003 and enters the 2:1 splitter 1420 via its second port. The 2:1 splitter 1420 effectively adds the optical signals received over its first set of ports to generate a final output optical signal output from the third port of the 2:1 splitter and over the component-side port 1009. In order to optimize the output power of the final output optical signal, the optical signals input to the 2:1 splitter should be in phase, or depending upon the internals of the 2:1 splitter 1420, have whatever phase difference optimizes power. In order to achieve this, the phase shift Δϕ of the phase shifter 1320 is chosen appropriately. In some embodiments, for example when the 2:1 splitter is a Y-branch splitter, the phase shift Δϕ is chosen to be an integer multiple of a minus the relative phase difference Δθ, to optimize the output power. It should be noted that in some embodiments, the phase shift Δϕ of the phase shifter 1320 is chosen to optimize other aspects of the final output optical signal, such as for example, signal strength, eye opening, and/or bit error rate of a modulated signal.

It should be noted that in some embodiments, rather than a separate emitter 1100 and PSR 1200, a single emitter of a type which also serves the function of a polarization splitter rotator is utilized. In those embodiments, the two component-side ports of that single emitter are coupled directly to the first and second waveguides 1001 1003.

It should be noted that the relative phase of the first component optical signal “TM as TE” emerging from the emitter 1100 and PSR 1200 over the first waveguide 1001 may lead or follow the phase of the second component optical signal “TE” emerging from the emitter 1100 and PSR 1200 over the second waveguide 1003.

Since only relative phase difference is relevant (rather than absolute phases), in some embodiments the phase shifter 1320 is located along the second waveguide 1003 and its phase shift Δϕ appropriately chosen.

Although the first component optical signal traversing the first waveguide 1001 has been characterized as “TM as TE”, and the second component optical signal traversing the second waveguide has been characterized as “TE”, as long as the optical signals emerging from the emitter 1100 and/or PSR 1200 are in the same (parallel) linearly polarized state supported by both the first and second waveguides 1001 1003, they may be appropriately phase shifted by the phase shifter 1320 and combined in the 2:1 splitter 1420. For example, in some contexts the emitter 1100 and PSR 1200 may split and rotate the polarization components such that the Eₓ component (TE) of the incoming optical signal is rotated 90° into a TM polarization and output as “TE as TM”, and the E_{y} component (TM) of the incoming optical signal is output as “TM”, both signals traversing over waveguides 1001 1003 which support “TM” mode transmission.

In some embodiments for which the polarization of the original optical signal is known, the phase shifter 1320 is a fixed passive element.

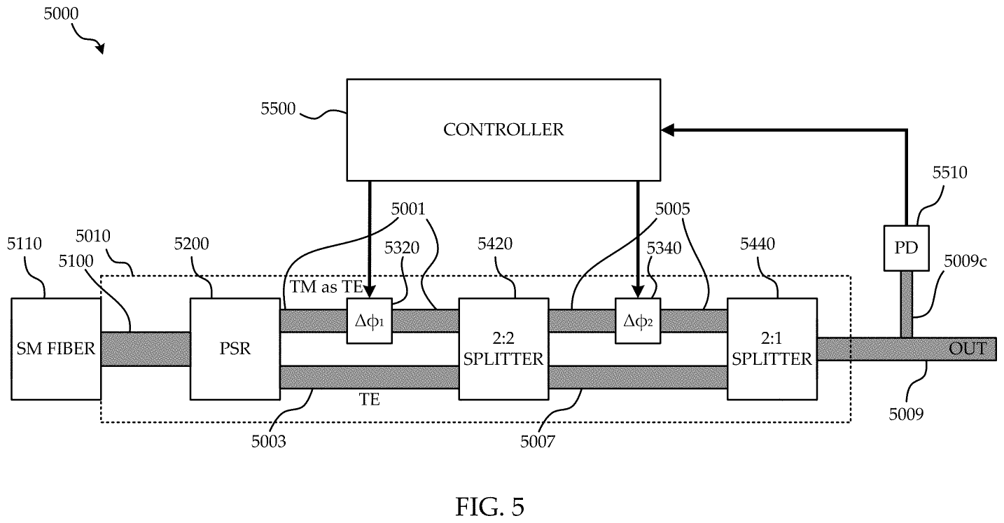

In some embodiments, to deal with various polarization states (having orthogonal components of equal magnitude), the phase shifter 1320 is tunable and the polarization controller includes active control of the phase shifter 1320 and optionally includes various elements for power monitoring such as taps and photodiodes (similar to those described below in association with FIG. 5) to provide feedback to a controller tuning the phase shift Δϕ.

The phase shifters 1320 of this and the remaining embodiments, may be implemented using various different technologies, including but not limited to: thermo-optic, electro-optic, carrier injection, carrier depletion, liquid crystal, or MEMS. Generally, thermo-optic technology is preferred due to its low optical loss.

In some embodiments, the polarization controller 1010 is reversed so that the first port of the emitter 1100 is utilized as an output of the polarization controller 1010 and the component-side port 1009 is utilized as the input of the polarization controller 1010. In such a case, a linearly polarized optical signal, e.g. “TE” is launched into the component-side port 1009, the signal is split and a relative phase difference Δϕ introduced by the phase shifter 1320 such that once rotated and recombined in the PSR 1200 and emitter 1100, the optical signal emerging from the emitter 1100 has the desired polarization, e.g. any optical signal which is 45° linearly polarized (e.g. from the x-axis), either of a “diagonal” or “anti-diagonal” polarization state, or right-hand circular polarized (RHCP), or left-hand circular polarized (LHCP), or in any elliptical polarization state which is formed by a combination of TE and TM of equal amplitudes and out-of-phase by amounts other than ±π/2, 0, or π Consequently, the phase shift Δϕ is determined taking into account both the desired polarization state of the output and the relative phase difference Δθ introduced by the emitter 1100 and PSR 1200.

Generally, the polarization controller 1010, using a combination of an emitter 1100 and/or PSR 1200, splits two orthogonal polarization components (having the same magnitude) of an incident optical signal and rotates one to be parallel with the other, and using a phase shifter 1320, controls the relative phase of the two component optical signals, prior to combining them in a 2:1 splitter, and alternatively (or simultaneously) can also perform the reverse operation.

In some embodiments of the type I polarization controller, the 2:1 splitter can be replaced with a 2:2 splitter, for example ignoring one path, including for example multimode interferometers (MMI) or directional couplers.

Such is the case with the integrated photonics system 2000 including a type I integrated polarization controller according to an embodiment, illustrated in FIG. 2, which will now be discussed.

The integrated photonics system 2000 includes an integrated polarization controller 2010 including an arrangement of on-chip photonics devices for converting any polarization state with orthogonal components e.g. Eₓ and E_{y} (TE and TM) having equal amplitudes, into a polarization state having substantially all of the incident power in a single component direction, e.g. Eₓ or TE. For example, an optical signal which is 45° linearly polarized (e.g. from the x-axis), either of a “diagonal” or “anti-diagonal” polarization state, right-hand circular polarized (RHCP), left-hand circular polarized (LHCP), or in any elliptical polarization state which is formed by a combination of TE and TM of equal amplitudes and out-of-phase by amounts other than ±π/2, 0, or π, may be converted into a linear polarization state e.g. TE of substantially the same power as the original optical signal.

Starting from a polarization-side of the system 2000, a first port of an emitter 2100 serves as the polarization-side port of the integrated polarization controller 2010. The emitter 2100 may be any free-space to chip converter that supports both polarization components (TE and TM), such as a grating or inverse taper, etc. A second port of the emitter 2100 is coupled to a single polarization-side port of a polarization splitter rotator (PSR) 2200 which is coupled via its component-side ports over a first set of waveguides 2001 2003 to a first set of ports on a polarization-side of a 2:2 splitter 2420. A first component-side port of the PSR 2200 is coupled to a first waveguide 2001 and a second component-side port of the PSR 2200 is coupled to a second waveguide 2003. A phase shifter 2320 is coupled along the first waveguide 2001. The first waveguide 2001 is coupled to a first port of the 2:2 splitter 2420, and the second waveguide 2003 is coupled to a second port of the 2:2 splitter 2420. A component-side of the 2:2 splitter 2420 is coupled via a second set of ports, consisting of a third and a fourth port respectively to two component-side ports 2009a 2009b of the integrated polarization controller 2010, represented here as waveguides one or both of which are coupled to further optical components which utilize the polarization converted optical signal.

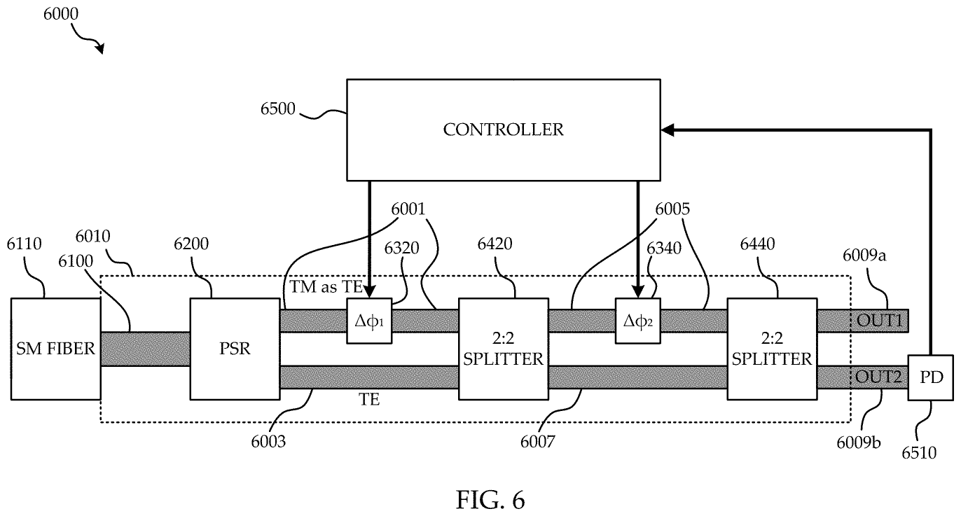

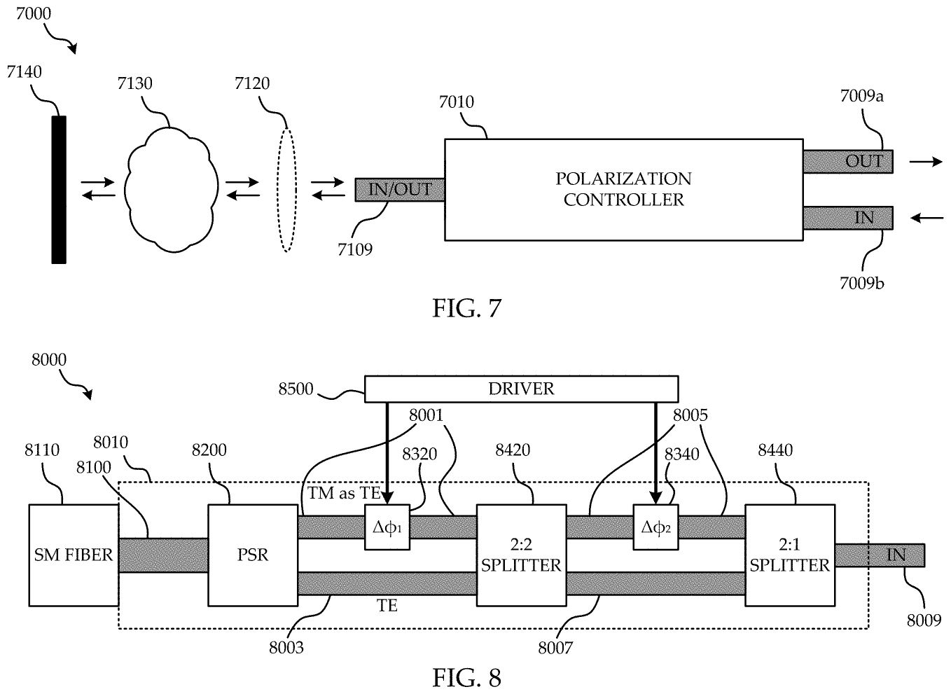

An original optical signal of the original polarization state is input to the integrated polarization controller 2010 at the emitter 2100. After traversing the emitter 2100, the optical signal enters the polarization splitter rotator (PSR) 2200 which splits the orthogonal polarization components of the optical signal, rotates one of them, and outputs them on separate component-side ports. The E_{y} component (TM) of the incoming optical signal is rotated 90° into a TE polarization, and output as a first component optical signal from a first component-side port of the PSR 2200 along the first waveguide 2001 “TM as TE”. The Eₓ component (TE) of the incoming optical signal is output as a second component optical signal from a second component-side port of the PSR 2200 along the second waveguide 2003 “TE”. The TE and TM polarization components of the optical signal see different phase shifts traversing both the emitter 2100 and the PSR 2200, since generally the effective indices affecting the TM and TE components are not equal. This will be reflected in the phases of the first and second component optical signals emerging from the PSR 2200. For the purposes of the operation of the polarization controller 2010, the absolute phases of the optical signals traversing the first set of waveguides 2001 2003 do not matter, only the relative phase difference Δθ between the optical signal traversing the first waveguide 2001 and the optical signal traversing the second waveguide 2003 matters. This relative phase difference Δθ depends not only on the phase shifts caused by the emitter 2100 and PSR 2200, but also on the original phase difference between the orthogonal polarization components of the original optical signal. The first component optical signal “TM as TE” passes through the phase shifter 2320 coupled along the first waveguide 2001 which imparts a phase shift of Δϕ in the first component optical signal. A phase shifted first component optical signal emerges from the phase shifter 2320, traverses the remainder of the first waveguide 2001 and enters the 2:2 splitter 2420 via its first port. The second component optical signal traverses the second waveguide 2003 and enters the 2:2 splitter 2420 via its second port. The 2:2 splitter 2420 effectively adds the optical signals received over its first set of ports to generate a final output optical signal output from one of the ports of its second set of ports, namely one of the third or fourth ports of the 2:2 splitter 2420 and over one of the component-side ports 2009a 2009b. The other one of its third or fourth port coupled to the other one of the component-side ports 2009a 2009b produces an optical signal which is the difference between the two optical signals received over the 2:2 splitter's 2420 first set of ports. In order to optimize the output power of the final output optical signal, the optical signals input to the 2:2 splitter should be in phase, or depending upon the internals of the 2:2 splitter 2420 (and which component-side port 2009a 2009b is being used as the “output”), have whatever phase difference optimizes power emerging over the intended component-side port 2009a 2009b. For example, a 2:2 splitter 2420 may be such that even-mode input optical signals optimizes power over one of the two component-side ports 2009a 2009b while minimizing the power over the other of the two component-side ports 2009a 2009b. In such a case, that same 2:2 splitter would likely be such that odd-mode input optical signals optimizes power over the other of the two component-side ports 2009a 2009b while minimizing the power over the one of the two component-side ports 2009a 2009b. It should be noted, that although in some embodiments only one of the two component-side ports 2009a 2009b is utilized as the desired output for the final output optical signal, whereas optical signals at the other of the two component-side ports 2009a 2009b are dumped or discarded, in some embodiments, optical signals at both component-side ports 2009a 2009b are utilized, and in some cases put to different use (similar to embodiments described in association with FIGS. 6 and 7).

In order to achieve this a proper relative phase difference for optimizing the output power, the phase shift Δϕ of the phase shifter 2320 is chosen appropriately. In some embodiments, the phase shift Δϕ is chosen to be an integer multiple of a minus the relative phase difference Δθ, while in other embodiments (where odd mode optimizes output) the phase shift Δϕ is chosen to be π minus the relative phase difference Δθ plus an integer multiple of 2π, in order to optimize the output power. It should be noted that in some embodiments, the phase shift Δϕ of the phase shifter 2320 is chosen to optimize other aspects of the final output optical signal, such as for example, signal strength, eye opening, and/or bit error rate of a modulated signal.

In some embodiments, rather than a separate emitter 2100 and PSR 2200, a single emitter or coupler of a type which also serves the function of a polarization splitter rotator is utilized. In those embodiments, the two component-side ports of that coupler are coupled directly to the first and second waveguides 2001 2003.

The relative phase of the first component optical signal “TM as TE” emerging from the emitter 2100 and PSR 2200 over the first waveguide 2001 may lead or follow the phase of the second component optical signal “TE” emerging from the emitter 2100 and PSR 2200 over the second waveguide 2003. In some embodiments the phase shifter 2320 is located along the second waveguide 2003 and its phase shift Δϕ appropriately chosen.

As long as the optical signals emerging from the emitter 2100 and/or PSR 2200 are in the same (parallel) linearly polarized state supported by both the first and second waveguides 2001 2003, they may be appropriately phase shifted by the phase shifter 2320 and combined in the 2:2 splitter 2420. For example, in some contexts the emitter 2100 and PSR 2200 may split and rotate the polarization components such that the Eₓ component (TE) of the incoming optical signal is rotated 90° into a TM polarization and output as “TE as TM”, and the E_{y} component (TM) of the incoming optical signal is output as “TM”, both signals traversing over waveguides 2001 2003 which support “TM” mode transmission.

In some embodiments, for which the polarization of the original optical signal is known, the phase shifter 2320 is a fixed passive element.

In some embodiments, to deal with various polarization states (having orthogonal components of equal magnitude), the phase shifter 2320 is tunable and the polarization controller includes active control of the phase shifter 2320 and optionally includes various elements for power monitoring such as taps and photodiodes (similar to those described below in association with FIG. 5) to provide feedback to a controller tuning the phase shift Δϕ.

In some embodiments (as described below in association with FIG. 7), the polarization controller 2010 is reversed so that the first port of the emitter 2100 is utilized as an output of the polarization controller 2010 and the component-side ports 2009a 2009b are utilized as the inputs of the polarization controller 2010. In such a case, a linearly polarized optical signal, e.g. “TE” is launched into one component-side port e.g. 2009a, the signal is split and a relative phase difference introduced by the phase shifter 2320 such that once rotated and recombined in the PSR 2200 and emitter 2100, the optical signal emerging from the emitter 2100 has the desired polarization, e.g. any optical signal which is 45° linearly polarized (e.g. from the x-axis), either of a “diagonal” or “anti-diagonal” polarization state, or right-hand circular polarized (RHCP), or left-hand circular polarized (LHCP), or in any elliptical polarization state which is formed by a combination of TE and TM of equal amplitudes and out-of-phase by amounts other than ±π/2, 0, or π The phase shift Δϕ is determined taking into account both the desired polarization state of the output and the relative phase difference Δθ introduced by the emitter 2100 and PSR 2200.

In some embodiments (as described below in association with FIG. 7), the polarization controller 2010 is used in both forward and reverse directions simultaneously. In such a case the first port of the emitter 2100 is utilized as both an input and an output of the polarization controller 2010 and one of the component-side ports 2009a 2009b is utilized as another input of the polarization controller 2010 while the other component-side port 2009a 2009b is utilized as another output of the polarization controller. In such a case, a linearly polarized optical signal, e.g. “TE” is launched into one component-side port, for example, the component-side port 2009b, the signal is split and a relative phase difference introduced by the phase shifter 2320 such that once rotated and recombined in the PSR 2200 and emitter 2100, the optical signal emerging from the emitter 2100 has the desired polarization, e.g. right-hand circular polarized (RHCP), or left-hand circular polarized (LHCP), which could be used to analyze a material sample (as in the example of FIG. 7), the optical signal taking on an opposite (LHCP or RHCP) circularly polarized state upon reflection back to the polarization controller 2010. Due to the opposite handedness of the returning the optical signal (as explained below), after traversing the polarization controller 2010 in the opposite direction, it emerges as a “TE” optical signal over component-side port 2009a.

The polarization controller 2010, using a combination of an emitter 2100 and/or PSR 2200, splits two orthogonal polarization components (having the same magnitude) of an incident optical signal and rotates one to be parallel with the other, and using a phase shifter 2320, controls the relative phase of the two component optical signals, prior to combining them in a 2:2 splitter, and can also perform the reverse operation, alternatively or simultaneously.

The type I polarization controllers 1010 2010 discussed above in association with FIGS. 1 and 2, although described as receiving or generating optical signals with polarization states having orthogonal components of equal magnitudes, they may be used with optical signals of other polarization states to varying degrees of loss of power in the resulting optical signals. To deal with optical signals of any polarization state, integrated polarization controllers of type II, as described below, may be utilized.

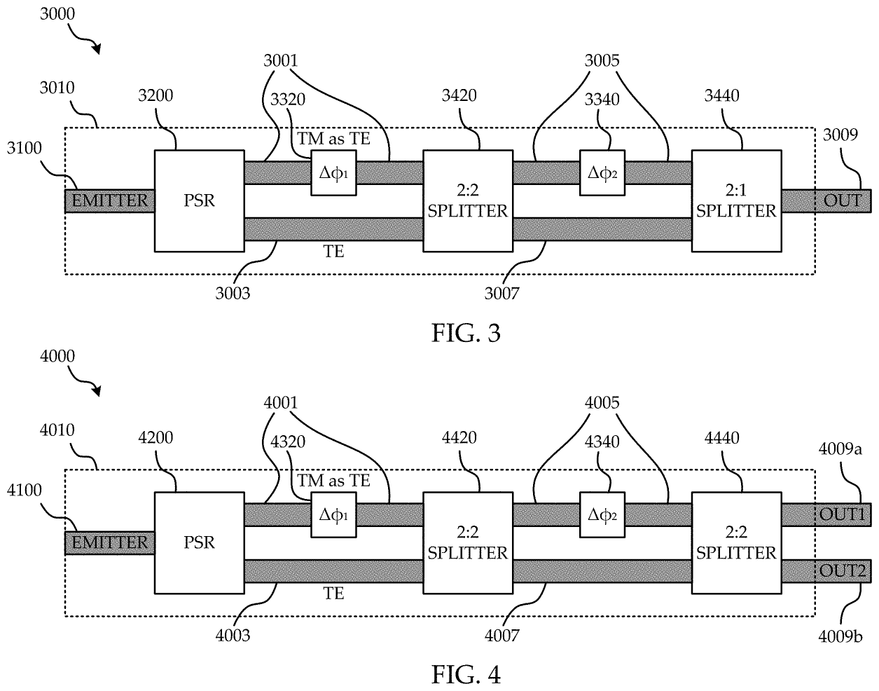

With reference to FIG. 3 an integrated photonics system 3000 including a type II integrated polarization controller according to an embodiment will now be discussed.

As was noted above in the description of the embodiments of FIGS. 1 and 2, the 2:1 splitter and the 2:2 splitter effectively add the first and second component optical signals they receive to generate the output optical signal, and generally in-phase inputs of similar magnitude optimizes output power over the component-side port of the polarization controller used as its output. If either the phases or the magnitudes are mismatched output power will not be optimized. This is why a polarization controller of type I is optimally used with optical signals having polarization components of equal magnitude. In order to allow operation with any polarization state, for which the polarization components are of any phase difference and having any ratio of magnitudes, rather than a single 2:1 splitter or 2:2 splitter, a variable splitter is utilized at the output of the polarization controller.

The integrated photonics system 3000 includes an integrated polarization controller 3010 including an arrangement of on-chip photonics devices for converting any polarization state with orthogonal components e.g. Eₓ and E_{y} (TE and TM) having arbitrary amplitudes, into a polarization state having substantially all of the incident power in a single component direction, e.g. Eₓ or TE. For example, an optical signal which is linearly, circularly, or elliptically polarized may be converted into a specific linear polarization state e.g. TE of substantially the same power as the original optical signal.

Starting from a polarization-side of the system 3000, a first port of an emitter 3100 serves as the polarization-side port of the integrated polarization controller 3010. The emitter 3100 may be any free-space to chip converter that supports both polarization components (TE and TM), such as a grating or inverse taper, etc. A second port of the emitter 3100 is coupled to a single polarization-side port of a polarization splitter rotator (PSR) 3200 which is coupled via its component-side ports over a first set of waveguides 3001 3003 to a first set of ports on a polarization-side of a 2:2 splitter 3420. A first component-side port of the PSR 3200 is coupled to a first waveguide 3001 and a second component-side port of the PSR 3200 is coupled to a second waveguide 3003. A first phase shifter 3320 is coupled along the first waveguide 3001. The first waveguide 3001 is coupled to a first port of the 2:2 splitter 3420, and the second waveguide 3003 is coupled to a second port of the 2:2 splitter 3420. A component-side of the 2:2 splitter 3420 is coupled via a second set of ports, consisting of a third and a fourth port, over a second set of waveguides 3005 3007 to a first set of ports on a polarization-side of a 2:1 splitter 3440. The 2:2 splitter 3420 is coupled via its third port to a third waveguide 3005 and is coupled via its fourth port to a fourth waveguide 3007. A second phase shifter 3340 is coupled along the third waveguide 3005. The third waveguide 3005 is coupled to a first port of the 2:1 splitter 3440, and the fourth waveguide 3007 is coupled to a second port of the 2:1 splitter 3440. A component-side of the 2:1 splitter 3440 is coupled via a second set of ports, consisting of a single third port, to a component-side port 3009 of the integrated polarization controller 3010, represented here as a waveguide coupled to further optical components which utilize the polarization converted optical signal.

An original optical signal of the original polarization state is input to the integrated polarization controller 3010 at the emitter 3100. After traversing the emitter 3100, the optical signal enters the polarization splitter rotator (PSR) 3200 which splits the orthogonal polarization components of the optical signal, rotates one of them, and outputs them on separate component-side ports. The E_{y} component (TM) of the incoming optical signal is rotated 90° into a TE polarization, and output as a first component optical signal from a first component-side port of the PSR 3200 along the first waveguide 3001 “TM as TE”. The Eₓ component (TE) of the incoming optical signal is output as a second component optical signal from a second component-side port of the PSR 3200 along the second waveguide 3003 “TE”. The TE and TM polarization components of the optical signal see different phase shifts traversing both the emitter 3100 and the PSR 3200, since generally the effective indices affecting the TM and TE components are not equal. This will be reflected in the phases of the first and second component optical signals emerging from the PSR 3200. For the purposes of the operation of the polarization controller 3010, the absolute phases of the optical signals traversing the first set of waveguides 3001 3003 do not matter, only the relative phase difference Δθ between the optical signal traversing the first waveguide 3001 and the optical signal traversing the second waveguide 3003 matters. This relative phase difference Δθ depends not only on the phase shifts caused by the emitter 3100 and PSR 3200, but also on the original phase difference between the orthogonal polarization components of the original optical signal. The first component optical signal “TM as TE” passes through the first phase shifter 3320 coupled along the first waveguide 3001 which imparts a first phase shift of Δϕ₁ in the first component optical signal. A phase shifted first component optical signal emerges from the first phase shifter 3320, traverses the remainder of the first waveguide 3001 and enters the 2:2 splitter 3420 via its first port. The second component optical signal traverses the second waveguide 3003 and enters the 2:2 splitter 3420 via its second port. The 2:2 splitter 3420 effectively adds the optical signals received over its first set of ports to generate an optical signal output from one of the ports of its second set of ports, the other port of its second set of ports producing an optical signal which is the difference between the two optical signals received over the first set of ports of the 2:2 splitter 3420. In order to ensure an equal power for the optical signals arriving at the 2:1 splitter 3440, the optical signals input to the 2:2 splitter 3420, regardless of their relative powers, should be ±90° (±π/2) out of phase, or depending upon the internals of the 2:2 splitter 3420, have whatever phase difference equalizes power of the signals emerging over the second set of waveguides 3005 and 3007. This ensures that the two optical signals emerging from the 2:2 splitter 3420, namely, one being the sum of the optical signals input to the 2:2 splitter 3420 and the other being the difference of the optical signals input to the 2:2 splitter 3420, have the same power.

In order to achieve this proper relative phase difference for equalizing the output power from the 2:2 splitter 3420, the first phase shift Δϕ₁ of the first phase shifter 3320 is chosen appropriately, namely, chosen to provide a relative phase difference of ±90° (±π/2). In some embodiments, the first phase shift Δϕ₁ is chosen to be an integer multiple of a minus the relative phase difference Δθ shifted by an additional ±90° (±π/2).

Third and fourth component optical signals, of equal power, emerge from the 2:2 splitter 3420 over the third and fourth waveguides 3005 3007 respectively. The third and fourth component optical signals launched from the 2:2 splitter 3420 onto the third and fourth waveguides 3005 3007 will have a relative phase difference Δθ₂ depending upon the relative magnitudes of the optical signals input to the 2:2 splitter 3420. The third component optical signal traversing the third waveguide 3005 passes through the second phase shifter 3340 coupled along the third waveguide 3005 which imparts a second phase shift of Δϕ₂ in the third component optical signal. A phase shifted third component optical signal emerges from the phase shifter 3340, traverses the remainder of the third waveguide 3005 and enters the 2:1 splitter 3440 via its first port. The fourth component optical signal traverses the fourth waveguide 3007 and enters the 2:1 splitter 3440 via its second port. The 2:1 splitter 3440 effectively adds the optical signals received over its first set of ports to generate a final output optical signal output from the third port of the 2:1 splitter 3440 and over the component-side port 3009. In order to optimize the output power of the final output optical signal, the optical signals input to the 2:1 splitter 3440 should be in phase, or depending upon the internals of the 2:1 splitter 3440, have whatever phase difference optimizes power. In order to achieve this, the second phase shift Δϕ₂ of the second phase shifter 3340 is chosen appropriately, and in some embodiments the second phase shift Δϕ₂ is chosen to be an integer multiple of a minus the second relative phase difference Δθ₂, to optimize the output power. It should be noted that in some embodiments, the second phase shift Δϕ₂ of the phase shifter 3340 is chosen to optimize other aspects of the final output optical signal, such as for example, signal strength, eye opening, and/or bit error rate of a modulated signal.

In some embodiments, rather than a separate emitter 3100 and PSR 3200, a single emitter of a type which also serves the function of a polarization splitter rotator is utilized. In those embodiments, the two component-side ports of that single emitter are coupled directly to the first and second waveguides 3001 3003. The relative phase of the first component optical signal “TM as TE” emerging from the emitter 3100 and PSR 3200 over the first waveguide 3001 may lead or follow the phase of the second component optical signal “TE” emerging from the emitter 3100 and PSR 3200 over the second waveguide 3003. In some embodiments one or both of the first and second phase shifters 3320 3340 are respectively located along the second and fourth waveguides 3003 3007 and their phase shifts Δϕ₁ Δϕ₂ appropriately chosen.

As long as the optical signals emerging from the emitter 3100 and/or PSR 3200 are in the same (parallel) linearly polarized state supported by both the first and second waveguides 3001 3003, they may be appropriately phase shifted by the first phase shifter 3320 and operated upon by the remaining elements of the polarization controller 3010. For example, in some contexts the emitter 3100 and PSR 3200 may split and rotate the polarization components such that the Eₓ component (TE) of the incoming optical signal is rotated 90° into a TM polarization and output as “TE as TM”, and the E_{y} component (TM) of the incoming optical signal is output as “TM”, both signals traversing over waveguides 3001 3003 which support “TM” mode transmission.

In some embodiments, for which the polarization of the original optical signal is known, the phase shifters 3320 3340 are fixed passive elements.

In some embodiments, to deal with arbitrary polarization states, the phase shifters 3320 3340 are tunable and the polarization controller includes active control of the phase shifters 3320 3340 and optionally includes various elements for power monitoring such as taps and photodiodes (similar to those described below in association with FIG. 5) to provide feedback to a controller tuning the phase shifts Δϕ₁ Δϕ₂.

In some embodiments, the polarization controller 3010 is reversed so that the first port of the emitter 3100 is utilized as an output of the polarization controller 3010 and the component-side port 3009 is utilized as the input of the polarization controller 3010. In such a case, a linearly polarized optical signal, e.g. “TE” is launched into the component-side port 3009, the signal is split and a relative phase difference Δϕ₂ introduced by the second phase shifter 3340, such that once split by the 2:2 splitter 3420 and a further relative phase difference Δϕ₁ introduced by the first phase shifter 3320, and once rotated and recombined in the PSR 3200 and emitter 3100, the optical signal emerging from the emitter 3100 has the desired polarization, e.g. any arbitrary linear, circular, or elliptical polarization state. Consequently, the phase shifts Δϕ₁ Δϕ₂ are determined taking into account both the desired polarization state of the output and the relative phase difference Δθ introduced by the emitter 3100 and PSR 3200.

Generally, the polarization controller 3010, using a combination of an emitter 3100 and/or PSR 3200, splits two orthogonal polarization components of an arbitrarily polarized incident optical signal and rotates one to be parallel with the other, and using a first phase shifter 3320, controls the relative phase of the two component optical signals so that they possess a relative phase difference of ±90° (±π/2) prior to traversing a 2:2 splitter 3420, from which optical signals emerge having equal power, one of which is further phase shifted using a second phase shifter 3340 by a phase shift of Δϕ₂ in order to bring them in-phase, prior to combining them in a 2:1 splitter 3440 for output, and can also (alternatively or simultaneously) perform the reverse operation.

In some embodiments of the type II polarization controller, the 2:1 splitter can be replaced with a component-side 2:2 splitter (for example ignoring one output), including for example multimode interferometers (MMI) or directional couplers.

Such is the case with the integrated photonics system 4000 including a type II integrated polarization controller according to an embodiment, illustrated in FIG. 4, which will now be discussed.

The integrated photonics system 4000 includes an integrated polarization controller 4010 including an arrangement of on-chip photonics devices for converting any polarization state with orthogonal components e.g. Eₓ and E_{y} (TE and TM) having arbitrary amplitudes, into a polarization state having substantially all of the incident power in a single component direction, e.g. Eₓ or TE. For example, an optical signal which is linearly, circularly, or elliptically polarized may be converted into a specific linear polarization state e.g. TE of substantially the same power as the original optical signal.

Starting from a polarization-side of the system 4000, a first port of an emitter 4100 serves as the polarization-side port of the integrated polarization controller 4010. The emitter 4100 may be any free-space to chip converter that supports both polarization components (TE and TM), such as a grating or inverse taper, etc. A second port of the emitter 4100 is coupled to a single polarization-side port of a polarization splitter rotator (PSR) 4200 which is coupled via its component-side ports over a first set of waveguides 4001 4003 to a first set of ports on a polarization-side of a polarization-side 2:2 splitter 4420. A first component-side port of the PSR 4200 is coupled to a first waveguide 4001 and a second component-side port of the PSR 4200 is coupled to a second waveguide 4003. A first phase shifter 4320 is coupled along the first waveguide 4001. The first waveguide 4001 is coupled to a first port of the polarization-side 2:2 splitter 4420, and the second waveguide 4003 is coupled to a second port of the polarization-side 2:2 splitter 4420. A component-side of the polarization-side 2:2 splitter 4420 is coupled via a second set of ports, consisting of a third and a fourth port, over a second set of waveguides 4005 4007 to a first set of ports on a polarization-side of a component-side 2:2 splitter 4440. The polarization-side 2:2 splitter 4420 is coupled via its third port to a third waveguide 4005 and is coupled via its fourth port to a fourth waveguide 4007. A second phase shifter 4340 is coupled along the third waveguide 4005. The third waveguide 4005 is coupled to a first port of the component-side 2:2 splitter 4440, and the fourth waveguide 4007 is coupled to a second port of the component-side 2:2 splitter 4440. A component-side of the component-side 2:2 splitter 4440 is coupled via a second set of ports, consisting of a third and a fourth port respectively to two component-side ports 4009a 4009b of the integrated polarization controller 4010, represented here as waveguides, one or both of which are coupled to further optical components which utilize the polarization converted optical signal.

An original optical signal of the original polarization state is input to the integrated polarization controller 4010 at the emitter 4100. After traversing the emitter 4100, the optical signal enters the polarization splitter rotator (PSR) 4200 which splits the orthogonal polarization components of the optical signal, rotates one of them, and outputs them on separate component-side ports. The E_{y} component (TM) of the incoming optical signal is rotated 90° into a TE polarization, and output as a first component optical signal from a first component-side port of the PSR 4200 along the first waveguide 4001 “TM as TE”. The Eₓ component (TE) of the incoming optical signal is output as a second component optical signal from a second component-side port of the PSR 4200 along the second waveguide 4003 “TE”. The TE and TM polarization components of the optical signal see different phase shifts traversing both the emitter 4100 and the PSR 4200, since generally the effective indices affecting the TM and TE components are not equal. This will be reflected in the phases of the first and second component optical signals emerging from the PSR 4200. For the purposes of the operation of the polarization controller 4010, the absolute phases of the optical signals traversing the first set of waveguides 4001 4003 do not matter, only the relative phase difference Δθ between the optical signal traversing the first waveguide 4001 and the optical signal traversing the second waveguide 4003 matters. This relative phase difference Δθ depends not only on the phase shifts caused by the emitter 4100 and PSR 4200, but also on the original phase difference between the orthogonal polarization components of the original optical signal. The first component optical signal “TM as TE” passes through the first phase shifter 4320 coupled along the first waveguide 4001 which imparts a first phase shift of Δϕ₁ in the first component optical signal. A phase shifted first component optical signal emerges from the first phase shifter 4320, traverses the remainder of the first waveguide 4001 and enters the polarization-side 2:2 splitter 4420 via its first port. The second component optical signal traverses the second waveguide 4003 and enters the polarization-side 2:2 splitter 4420 via its second port. The 2:2 splitter 4420 effectively adds the optical signals received over its first set of ports to generate an optical signal output from one of the ports of its second set of ports, the other port of its second set of ports producing an optical signal which is the difference between the two optical signals received over the first set of ports of the polarization-side 2:2 splitter 4420. In order to ensure an equal power for the optical signals arriving at the component-side 2:2 splitter 4440, the optical signals input to the polarization-side 2:2 splitter 4420, regardless of their relative powers, should be ±90° (±π/2) out of phase, or depending upon the internals of the 2:2 splitter 4420, have whatever phase difference equalizes power of the signals emerging over the second set of waveguides 4005 and 4007. This ensures that the two optical signals emerging from the polarization-side 2:2 splitter 4420, namely, one being the sum of the optical signals input to the polarization-side 2:2 splitter 4420 and the other being the difference of the optical signals input to the polarization-side 2:2 splitter 4420, have the same power.

In order to achieve this a proper relative phase difference for equalizing the output power from the polarization-side 2:2 splitter 4420, the first phase shift Δϕ₁ of the first phase shifter 4320 is chosen appropriately, namely, chosen to provide a relative phase difference of ±90° (±π/2). In some embodiments, the first phase shift Δϕ₁ is chosen to be an integer multiple of a minus the relative phase difference Δθ shifted by an additional ±90° (±π/2).

Third and fourth component optical signals, of equal power, emerge from the polarization-side 2:2 splitter 4420 over the third and fourth waveguides 4005 4007 respectively. The third and fourth component optical signals launched from the polarization-side 2:2 splitter 4420 onto the third and fourth waveguides 4005 4007 will have a relative phase difference Δθ₂ depending upon the relative magnitudes of the optical signals input to the polarization-side 2:2 splitter 4420. The third component optical signal traversing the third waveguide 4005 passes through the second phase shifter 4340 coupled along the third waveguide 4005 which imparts a second phase shift of Δϕ₂ in the third component optical signal. A phase shifted third component optical signal emerges from the phase shifter 4340, traverses the remainder of the third waveguide 4005 and enters the component-side 2:2 splitter 4440 via its first port. The fourth component optical signal traverses the fourth waveguide 4007 and enters the component-side 2:2 splitter 4440 via its second port. The component-side 2:2 splitter 4440 effectively adds the optical signals received over its first set of ports to generate a final output optical signal output from one of the ports of its second set of ports, namely one of the third or fourth ports of the component-side 2:2 splitter 4440 and over one of the component-side ports 4009a 4009b. The other one of its third or fourth port coupled to the other one of the component-side ports 4009a 4009b produces an optical signal which is the difference between the two optical signals received over the component-side 2:2 splitter's 4440 first set of ports.

In order to optimize the output power of the final output optical signal, the optical signals input to the component-side 2:2 splitter 4440 should be in phase, or depending upon the internals of the component-side 2:2 splitter 4440, have whatever phase difference optimizes power. In order to achieve this, the second phase shift Δϕ₂ of the second phase shifter 4340 is chosen appropriately, and in some embodiments the second phase shift Δϕ₂ is chosen to be an integer multiple of a minus the second relative phase difference Δθ₂, to optimize the output power. It should be noted that in some embodiments, the second phase shift Δϕ₂ of the phase shifter 4340 is chosen to optimize other aspects of the final output optical signal, such as for example, signal strength, eye opening, and/or bit error rate of a modulated signal.

In some embodiments, rather than a separate emitter 4100 and PSR 4200, a single emitter of a type which also serves the function of a polarization splitter rotator is utilized. In those embodiments, the two component-side ports of that single emitter are coupled directly to the first and second waveguides 4001 4003. The relative phase of the first component optical signal “TM as TE” emerging from the emitter 4100 and PSR 4200 over the first waveguide 4001 may lead or follow the phase of the second component optical signal “TE” emerging from the emitter 4100 and PSR 4200 over the second waveguide 4003. In some embodiments one or both of the first and second phase shifters 4320 4340 are respectively located along the second and fourth waveguides 4003 4007 and their phase shifts Δϕ₁ Δϕ₂ appropriately chosen.

As long as the optical signals emerging from the emitter 4100 and/or PSR 4200 are in the same (parallel) linearly polarized state supported by both the first and second waveguides 4001 4003, they may be appropriately phase shifted by the first phase shifter 4320 and operated upon by the remaining elements of the polarization controller 4010. For example, in some contexts the emitter 4100 and PSR 4200 may split and rotate the polarization components such that the Eₓ component (TE) of the incoming optical signal is rotated 90° into a TM polarization and output as “TE as TM”, and the E_{y} component (TM) of the incoming optical signal is output as “TM”, both signals traversing over waveguides 4001 4003 which support “TM” mode transmission.

In some embodiments, for which the polarization of the original optical signal is known, the phase shifters 4320 4340 are fixed passive elements.

In some embodiments, to deal with arbitrary polarization states, the phase shifters 4320 4340 are tunable and the polarization controller includes active control of the phase shifters 4320 4340 and optionally includes various elements for power monitoring such as taps and photodiodes (similar to those described below in association with FIG. 5) to provide feedback to a controller tuning the phase shifts Δϕ₁ Δϕ₂.

In some embodiments (as described below in association with FIG. 7), the polarization controller 4010 is reversed so that the first port of the emitter 4100 is utilized as an output of the polarization controller 4010 and the component-side ports 4009a 4009b are utilized as the inputs of the polarization controller 4010. In such a case, a linearly polarized optical signal, e.g. “TE” is launched into one component-side port e.g. 4009a, the signal is split and a relative phase difference 442 introduced by the second phase shifter 4340, such that once split by the polarization-side 2:2 splitter 4420 and after a further relative phase difference Δϕ₁ introduced by the first phase shifter 4320, is such that once rotated and recombined in the PSR 4200 and emitter 4100, the optical signal emerging from the emitter 4100 has the desired polarization, e.g. any arbitrary linear, circular, or elliptical polarization state. Consequently, the phase shifts Δϕ₁ Δϕ₂ are determined taking into account both the desired polarization state of the output and the relative phase difference Δθ introduced by the emitter 4100 and PSR 4200.

In some embodiments (as described below in association with FIG. 7), the polarization controller 4010 is used in both forward and reverse directions simultaneously. In such a case the first port of the emitter 4100 is utilized as both an input and an output of the polarization controller 4010 and one of the component-side ports 4009a 4009b is utilized as another input of the polarization controller 4010 while the other component-side port 4009a 4009b is utilized as another output of the polarization controller. In such a case, a linearly polarized optical signal, e.g. “TE” is launched into one component-side port, for example, the component-side port 4009b, the signal is split and a relative phase difference introduced by the second phase shifter 4340, such that once split by the polarization-side 2:2 splitter 4420 and after a further relative phase difference Δϕ₁ introduced by the first phase shifter 4320, and once rotated and recombined in the PSR 4200 and emitter 4100, the optical signal emerging from the emitter 4100 has the desired polarization, e.g. right-hand circular polarized (RHCP), or left-hand circular polarized (LHCP), which could be used to analyze a material sample (as in the example of FIG. 7), the optical signal taking on an opposite (LHCP or RHCP) circularly polarized state upon reflection back to the polarization controller 4010. Due to the opposite handedness of the returning the optical signal (as explained below), after traversing the polarization controller 4010 in the opposite direction, it emerges as a “TE” optical signal over component-side port 4009a.

Generally, the polarization controller 4010, using a combination of an emitter 4100 and/or PSR 4200, splits two orthogonal polarization components of an arbitrarily polarized incident optical signal and rotates one to be parallel with the other, and using a first phase shifter 4320, controls the relative phase of the two component optical signals so that they possess a relative phase difference of ±90° (±π/2) prior to traversing a polarization-side 2:2 splitter 4420, from which optical signals emerge having equal power, one of which is further phase shifted using a second phase shifter 4440 by a phase shift of Δϕ₂ in order to bring them in-phase or otherwise to have a relative phase which optimizes power, prior to combining them in the component-side 2:2 splitter 4440 for output, and can also perform the reverse operation.

With reference to FIG. 5 an integrated photonics system 5000 including a type II integrated polarization controller 5010 such as that illustrated in FIG. 3, which is controllable based on feedback according to an embodiment will now be described.

Type II integrated polarization controllers such as those illustrated in FIGS. 3 and 4 are well suited for dealing with optical signals of any arbitrary polarization state. However, in the context of receiving an optical signal whose polarization state is not known, such as the output from photonic circuitry or devices utilizing single-mode (non-polarization maintaining) fiber, the phase shifts provided by the first and second phase shifters should be adjusted in response to the polarization of the original optical signal. In order to achieve this some form of detection and feedback control should be implemented.

Starting from a polarization-side of the system 5000, a first port of a coupler 5100 serves as the polarization-side port of the integrated polarization controller 5010, and receives an original optical signal from, for example, a single mode (SM) fiber 5110. The coupler 5100 can be a dual-polarization fiber coupler or any free-space to chip converter that supports both polarization components (TE and TM), such as a grating or inverse taper, etc. A second port of the coupler 5100 is coupled to a single polarization-side port of a polarization splitter rotator (PSR) 5200 which is coupled via its component-side ports over a first set of waveguides 5001 5003 to a first set of ports on a polarization-side of a 2:2 splitter 5420. A first component-side port of the PSR 5200 is coupled to a first waveguide 5001 and a second component-side port of the PSR 5200 is coupled to a second waveguide 5003. A first tunable phase shifter 5320 is coupled along the first waveguide 5001. The first waveguide 5001 is coupled to a first port of the 2:2 splitter 5420, and the second waveguide 5003 is coupled to a second port of the 2:2 splitter 5420. A component-side of the 2:2 splitter 5420 is coupled via a second set of ports, consisting of a third and a fourth port, over a second set of waveguides 5005 5007 to a first set of ports on a polarization-side of a 2:1 splitter 5440. The 2:2 splitter 5420 is coupled via its third port to a third waveguide 5005 and is coupled via its fourth port to a fourth waveguide 5007. A second tunable phase shifter 5340 is coupled along the third waveguide 5005. The third waveguide 5005 is coupled to a first port of the 2:1 splitter 5440, and the fourth waveguide 5007 is coupled to a second port of the 2:1 splitter 5440. A component-side port of the 2:1 splitter 5440 is coupled to a component-side port 5009 of the integrated polarization controller 5010, represented here as a waveguide coupled to further optical components which utilize the polarization converted optical signal. An optical tap 5009c is coupled to the component-side port 5009 of the integrated polarization controller 5010. A light detecting element such as a photodiode 5510 is coupled to the tap 5009c. The photodiode 5510 is electrically coupled to a controller 5500 which is itself electrically coupled to the first and second tunable phase shifters 5320 5340.

The integrated polarization controller 5010 of FIG. 5 functions in a substantially similar way to the embodiment illustrated in FIG. 3, however additional elements provide detection, feedback, and control to optimize power or some other aspect of the output signal. The optical tap 5009c coupled to the component-side port 5009 of the integrated polarization controller 5010, is for tapping a small amount of the output optical signal (e.g. 1%). The photodiode 5510 is for measuring an intensity and hence a power of the output optical signal traversing the output 5009 using the light received over the tap 5009c. The controller 5500 receives electrical signals from the photodiode 5510 indicative of the amount of light measured. In response to this measurement, the controller 5500 determines what the first and second phase shifts imparted by the first and second phase shifters 5320 5340 should be, or by how much either or both should be adjusted. The controller 5500 then sends electrical control signals to the first and second phase shifters 5320 5340 to adjust one or both of them appropriately. The control loop can be used in a systematic way to search out and find the optimal settings for the first and second phase shifters 5320 5340 when the original optical signal's polarization state is completely unknown, for example on start-up of the photonic circuitry coupled to the SM fiber 5110, when its operation is interrupted, or otherwise whenever the polarization state momentarily changes drastically. The control loop can also be used to make minor or continuous adjustments to the first and second phase shifters 5320 5340 to maintain an optimum power as the polarization state of the original optical signal drifts, shifts, or otherwise changes slowly.

With reference to FIG. 6 an integrated photonics system 6000 including a type II integrated polarization controller 6010 such as that illustrated in FIG. 4, which is controllable based on feedback from one of its component-side ports according to an embodiment.

As with the embodiment discussed in association with FIG. 5, in the context of receiving an optical signal whose polarization state is not known, the phase shifts provided by the first and second phase shifters are adjusted in response to the polarization of the original optical signal utilizing detection and feedback control.

Starting from a polarization-side of the system 6000, a first port of a coupler 6100 serves as the polarization-side port of the integrated polarization controller 6010, and receives an original optical signal from, for example, a single mode (SM) fiber 6110. The coupler 6100 can be a dual-polarization fiber coupler or any free-space to chip converter that supports both polarization components (TE and TM), such as a grating or inverse taper, etc. A second port of the coupler 6100 is coupled to a single polarization-side port of a polarization splitter rotator (PSR) 6200 which is coupled via its component-side ports over a first set of waveguides 6001 6003 to a first set of ports on a polarization-side of a polarization-side 2:2 splitter 6420. A first component-side port of the PSR 6200 is coupled to a first waveguide 6001 and a second component-side port of the PSR 6200 is coupled to a second waveguide 6003. A first tunable phase shifter 6320 is coupled along the first waveguide 6001. The first waveguide 6001 is coupled to a first port of the polarization-side 2:2 splitter 6420, and the second waveguide 6003 is coupled to a second port of the polarization-side 2:2 splitter 6420. A component-side of the polarization-side 2:2 splitter 6420 is coupled via a second set of ports, consisting of a third and a fourth port, over a second set of waveguides 6005 6007 to a first set of ports on a polarization-side of a component-side 2:2 splitter 6440. The polarization-side 2:2 splitter 6420 is coupled via its third port to a third waveguide 6005 and is coupled via its fourth port to a fourth waveguide 6007. A second tunable phase shifter 6340 is coupled along the third waveguide 6005. The third waveguide 6005 is coupled to a first port of a component-side 2:2 splitter 6440, and the fourth waveguide 6007 is coupled to a second port of the component-side 2:2 splitter 6440. A component-side of the component-side 2:2 splitter 6440 is coupled via a second set of ports, consisting of a third and a fourth port respectively to two component-side ports 6009a 6009b of the integrated polarization controller 6010, represented here as waveguides, one component-side port 6009a of which is coupled to further optical components which utilize the polarization converted optical signal. The other component-side port 6009b from which light would otherwise be discarded, is coupled to a light detecting element such as a photodiode 6510. The photodiode 6510 is electrically coupled to a controller 6500 which is itself electrically coupled to the first and second tunable phase shifters 6320 6340.

The integrated polarization controller 6010 of FIG. 6 functions in a substantially similar way to the embodiment illustrated in FIG. 4, however additional elements provide detection, feedback, and control to optimize power or some other aspect of the output signal. The photodiode 6510 is for measuring an intensity and hence a power of the output optical signal traversing the other component-side port 6009b. Due to the internals of the component-side 2:2 splitter 6440, the intensity of light emerging from the other component-side port 6009b, which otherwise would be discarded, provides information about the intensity of the output optical signal emerging from the one component-side port 6009a of the polarization controller 6010 which is used for the output optical signal. In particular, when the measured intensity of light at the photodiode 6510 is minimized, the power at the component-side port 6009a utilized as the output is optimized. The controller 6500 receives electrical signals from the photodiode 6510 indicative of the amount of light measured. In response to this measurement, the controller 6500 determines what the first and second phase shifts imparted by the first and second phase shifters 6320 6340 should be, or by how much either or both should be adjusted. The controller 6500 then sends electrical control signals to the first and second phase shifters 6320 6340 to adjust one or both of them appropriately. The control loop can be used in a systematic way to search out and find the optimal settings for the first and second phase shifters 6320 6340 when the original optical signal's polarization state is completely unknown, for example on start-up of the photonic circuitry coupled to the SM fiber 6110, when its operation is interrupted, or otherwise whenever the polarization state momentarily changes drastically. The control loop can also be used to make minor or continuous adjustments to the first and second phase shifters 6320 6340 to maintain an optimum power as the polarization state of the original optical signals drifts, shifts, or otherwise changes slowly.

In some embodiments, in addition to the photodiode coupled to the other component-side port 6009b of the polarization controller 6010, an additional tap coupled to the one component-side port 6009a with its own photodiode, is also electrically coupled to the controller 6500 for feedback control. In other embodiments, both component-side ports 6009a 6009b are coupled to taps with their own photodetectors which are coupled to the controller 6500, enabling both component-side ports 6009a 6009b to be utilized for optical signal output or input (for example as is the case in the embodiment illustrated in FIG. 7). Utilizing two detection elements to monitor power and/or phase can provide more information for improved control of the first and second phase shifters 6320 6340. Additional taps and photodiodes may be provided along waveguides 6001, 6003, 6005, and 6007 for additional power monitoring, enabling more efficient and/or more accurate adjustment of the control loop. For example, monitoring for equal power emerging over the second set of waveguides 6005, 6007 can be used directly to adjust the first phase shifter 6320.

It should be noted that a polarization controller such as that illustrated in FIG. 5 or 6 or any other variation with feedback and a control loop, can be utilized as a polarimeter. While being input with an original optical signal having an arbitrary or otherwise unknown polarization state, the phase shifters of the polarization controller can be adjusted until power is maximized at one of its component-side port outputs. The drive voltages or other electrical control signals used to drive the phase shifters are indicative of the phase shifts applied to the optical signal which results in that maximum power. From those phase shifts, the original polarization state of the original optical signal may be deduced. In a similar manner to that discussed above, additional power monitoring of the power in waveguides 6001, 6003, 6005, 6007, as well as 6009a, and/or 6009b with taps and photodiodes may be used to deduce the input polarization state directly, while reducing the need for or dispensing entirely with the tuning of the first and/or second phase shifters or the tracking of the drive voltages or other electrical control signals.

An example application of an integrated photonics system 7000 including a type I or type II polarization controller such as illustrated in FIGS. 2 and 4, with or without taps and an associated controller, in a circular polarization reflectance sensor is illustrated in FIG. 7.

For purposes of discussing the sensor system 7000 of FIG. 7, the “polarization-side” of the device may also be referred to as the “sensing-side” of the device, and the “component-side” of the device may also be referred to as the “device-side” of the device.

A sensing-side port 7109 serves as the input and output of the integrated polarization controller 7010. It launches a sensing optical signal and simultaneously receives a reflected optical signal after it has interacted with a material sample as described below. The polarization controller 7010 includes all of the elements of and functions as either the type I polarization controller of FIG. 2 or the type II polarization controller of FIG. 4, optionally with a controller and one or more taps and photodiodes similar to those illustrated in FIG. 5. A device-side input and a device-side output of the polarization controller 7010, are represented here as waveguides, 7009a 7009b.

A linearly polarized optical signal e.g. Eₓ or TE is input to the device-side input 7009b. After passing though the polarization controller 7010, it emerges as an output via the sensing-side port 7109 as a circularly polarized optical signal e.g. right handed circularly polarized (RHCP). The RHCP sensing signal passes through an optional collimating lens 7120, and passes through a material sample (optional) to be measured 7130. Behind the material sample 7130 is optionally positioned a reflector such as a mirror 7140. The RHCP optical signal is reflected by the mirror 7140 and upon reflection becomes left-handed circularly polarized (LHCP) which returns as a measurement optical signal at the sensing-side port 7109 of the polarization controller 7010 after traversing the material sample 7130 and the lens 7120 a second time. After traversing the polarization controller 7010 in the other direction it emerges as a linearly polarized optical signal e.g. Eₓ or TE from the device-side output 7009a. Measurement of the power of the output optical signal reveals information about the material sample 7130 and/or reflector 7140 since in general it is proportional to the power of the received measurement optical signal.

It should be noted that should the material sample 7130 consist of birefringent material, the analysis can involve tuning the polarization controller 7010 so as to generate polarization states which are not LHCP or RHCP when they emerge from the sensing-side port 7109, but do possess that property once they pass through the material sample 7130. In such a case the circularly polarized light will reverse in handedness once it is reflected from the mirror 7140.

In some embodiments, such as in sensing and spectroscopy applications, the material sample 7130 is primarily transmissive and the light measured by the system 7000 consists primarily of light which has passed through the sample 7130 and has been reflected back from the mirror 7140.

In some embodiments, such as in LIDAR applications, the reflector 7140 rather than a mirror is a diffuse reflector and not a specular reflector, and the material of interest itself is the reflector 7140, and hence a separate material sample 7130 between the reflector 7140 and the polarization controller 7010 is not present.

It should be understood that either of the device-side ports 7009a 7009b may be utilized as the input while the other operates as the output. It also should be understood that either LHCP or RHCP signals may be launched from the polarization controller 7010, and due to the configuration thereof, optical signals of the opposite handedness will automatically be converted and output over device-side output 7009a as a linearly polarized signal e.g. TE.

An example application of an integrated photonics system 8000 including a type II polarization controller such as illustrated in FIG. 4, in a polarization scrambler is illustrated in FIG. 8.

A polarization scrambler generates an optical signal with a rapidly and/or randomly varying polarization state. The resulting scrambled optical signal is useful for testing and measurement of optical devices and/or otherwise for any application that utilizes an optical signal which is effectively depolarized.

For purposes of discussing the scrambler system 8000 of FIG. 8, the “polarization-side” of the device may also be referred to as the “output-side” of the device, and the “component-side” of the device may also be referred to as the “input-side” of the device.

Starting from a polarization-side of the system 8000, a first port of a coupler 8100 serves as the output of the integrated polarization controller 8010, and launches a scrambled optical signal into, for example, a single mode (SM) fiber 8110 or free-space. The coupler 8100 can be a dual-polarization fiber coupler or any free-space to chip converter that supports both polarization components (TE and TM), such as a grating or inverse taper, etc. A second port of the coupler 8100 is coupled to a single output-side port of a polarization splitter rotator (PSR) 8200 which is coupled via its input-side ports over a first set of waveguides 8001 8003 to a first set of ports on an output-side of a 2:2 splitter 8420. A first input-side port of the PSR 8200 is coupled to a first waveguide 8001 and a second input-side port of the PSR 8200 is coupled to a second waveguide 8003. A first tunable phase shifter 8320 is coupled along the first waveguide 8001. The first waveguide 8001 is coupled to a first port of the 2:2 splitter 8420, and the second waveguide 8003 is coupled to a second port of the 2:2 splitter 8420. An input-side of the 2:2 splitter 8420 is coupled via a second set of ports, consisting of a third and a fourth port, over a second set of waveguides 8005 8007 to a first set of ports on an output-side of a 2:1 splitter 8440. The 2:2 splitter 8420 is coupled via its third port to a third waveguide 8005 and is coupled via its fourth port to a fourth waveguide 8007. A second tunable phase shifter 8340 is coupled along the third waveguide 8005. The third waveguide 8005 is coupled to a first port of the 2:1 splitter 8440, and the fourth waveguide 8007 is coupled to a second port of the 2:1 splitter 8440. An input-side port of the 2:1 splitter 8440 is coupled to an input-side port 8009 of the integrated polarization controller 8010, represented here as a waveguide coupled to further optical components which provide the original optical signal. A driver 8500 is electrically coupled to the first and second tunable phase shifters 8320 8340.

The integrated polarization controller 8010 of FIG. 8 functions in a substantially similar way to the embodiment illustrated in FIG. 3, however additional elements provide control of the phase shifters 8320 8340, and optical signals traverse the polarization scrambler 8000 in the reverse direction.

A linearly polarized optical signal e.g. Eₓ or TE is input to the input-side port 8009. The driver 8500 controls the phase shifters 8320 8340 with electrical signals that impose randomly and/or rapidly changing phase shifts to the optical signals passing therethrough. After passing though the polarization controller 8010, the optical signal emerges as a polarization scrambled optical signal, having randomly and/or rapidly varying polarization states.

In some embodiments, fast phase shifters such as carrier-based modulation or Pockels-effect modulation shifters are utilized for the phase shifters 8320 8340, to effect faster scrambling.

It should be understood that feedback, controlling, and driving circuitry, such as that illustrated in FIGS. 5, 6, 7, and 8, may comprise processors, memory, interfaces, and/or other components which are either external to or implemented in the same integrated platform as the integrated polarization controller, including for example, being integrated within the same substrate or die, being integrated or co-located on a common substrate or platform, or being electrically and/or optically coupled across multiple platforms including the integrated polarization controller in a same or across multiple devices.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. An integrated photonics system comprising:
a photonics chip including a polarization controller having a polarization-side port and at least one component-side port, the polarization controller comprising:
a polarization splitter rotator (PSR) including a first, a second, and a third port, the PSR coupled via its first port, over the polarization-side port;
a first set of waveguides coupled to the second and third ports of the PSR;
a first phase shifter coupled along a first waveguide of the first set of waveguides; and
a first splitter including a first set of ports and a second set of ports, the first splitter coupled to the PSR via its first set of ports and over the first set of waveguides, and coupled over at least one port of its second set of ports, via the at least one component-side port of the polarization controller.

2. The integrated photonics system of claim 1, wherein the first splitter comprises a 2:1 splitter.

3. The integrated photonics system of claim 1, wherein the first splitter comprises a 2:2 splitter.

4. The integrated photonics system of claim 1, wherein the first phase shifter is configured for imparting a phase shift which optimizes optical signals emerging from at least one port of the at least one component-side port of the polarization controller.

5. The integrated photonics system of claim 1, wherein the first phase shifter is configured for imparting a phase shift which generates an optical signal having a selected polarization state emerging from the polarization-side port of the polarization controller.

6. The integrated photonics system of claim 1, wherein the first phase shifter is tunable.

7. The integrated photonics system of claim 6, further comprising:
at least one power detection element coupled along the at least one component-side port of the polarization controller, and wherein the controller, the at least one power detection element, and the tunable first phase shifter are comprised in a feedback loop for tuning a first phase shift of the first phase shifter.

8. The integrated photonics system of claim 1, further comprising:
a second set of waveguides coupled to the first set of ports of the first splitter;
a second phase shifter coupled along a first waveguide of the second set of waveguides;
a second splitter including a first set of ports and a second set of ports, the second splitter coupled via its first set of ports to the first set of waveguides and coupled via its second set of ports to the second set of waveguides, the second splitter coupled over the first set of waveguides to the PSR and coupled over the second set of waveguides to the first splitter.

9. The integrated photonics system of claim 8, wherein the first splitter comprises a 2:1 splitter and the second splitter comprises a 2:2 splitter.

10. The integrated photonics system of claim 8, wherein the first splitter comprises a 2:2 splitter and the second splitter comprises a 2:2 splitter.

11. The integrated photonics system of claim 8, wherein the first and second phase shifters are configured for imparting phase shifts which optimize optical signals emerging from at least one port of the at least one component-side port of the polarization controller.

12. The integrated photonics system of claim 8, wherein the first and second phase shifters are configured for imparting phase shifts which generate an optical signal having a selected polarization state emerging from the polarization-side port of the polarization controller.

13. The integrated photonics system of claim 8, wherein the first and second phase shifters are tunable.

14. The integrated photonics system of claim 13, further comprising:
at least one power detection element coupled along the at least one component-side port of the polarization controller and a controller, and
wherein the controller, the at least one power detection element, and the tunable first and second phase shifters are comprised in a feedback loop for tuning the phase shifts of the tunable first and second phase shifters.

15. The integrated photonics system of claim 14, wherein the at least one power detection element comprises at least one photodetector coupled via a tap to at least one port of the at least one component-side ports of the polarization controller, and wherein the controller in response to signals from the at least one photodetector controls at least one electrical control signal sent to the tunable first and second phase shifters.

16. The integrated photonics system of claim 15, wherein the at least one power detection element comprises a photodetector coupled to a port of the at least one component-side ports of the polarization controller, and wherein the controller in response to signals from the photodetector controls at least one electrical control signal sent to the tunable first and second phase shifters.

17. The integrated photonics system of claim 3, wherein the first phase shifter is configured to impart a phase shift for generating a circularly polarized sensing optical signal transmitted from the polarization-side port of the polarization controller, and for outputting over one of the at least one component-side ports of the polarization controller a linearly polarized optical signal having an optical power proportional to a circularly polarized measurement optical signal received over the polarization-side port of the polarization controller, the circularly polarized sensing optical signal transmitted being of the opposite handedness to the circularly polarized measurement optical signal received.

18. The integrated photonics system of claim 10, wherein the first and second phase shifters are configured to impart phase shifts for generating a circularly polarized sensing optical signal transmitted from the polarization-side port of the polarization controller, and for outputting over one of the at least one component-side ports of the polarization controller a linearly polarized optical signal having an optical power proportional to a circularly polarized measurement optical signal received over the polarization-side port of the polarization controller, the circularly polarized sensing optical signal transmitted being of the opposite handedness to the circularly polarized measurement optical signal received.

19. The integrated photonics system of claim 13, further comprising:
a driver for driving the phase shifts of the tunable first and second phase shifters in at least one of a rapid and random fashion so as to produce an optical signal which effectively has a scrambled polarization state.
